(19) United States
(12) Patent Application Publication
(10) Pub. No.: US 2023/0245007 A1
(43) Pub. Date: Aug. 3, 2023

(54) USER SEGMENTATION METHOD BASED ON TOLL DATA OF EXPRESSWAY ELECTRONIC TOLL COLLECTION

(71) Applicant: Shandong Jianzhu University, Jinan (CN)

(72) Inventors: Jianmin Jia, Jinan (CN); Hui Zhang, Jinan (CN); Baiying Shi, Jinan (CN)

(21) Appl. No.: 18/094,243

(22) Filed: Jan. 6, 2023

(30) Foreign Application Priority Data
Jan. 30, 2022 (CN) 2022101143064

(51) Int. Cl. G06Q 10/047; G06Q 30/04

(52) U.S. Cl. CPC G06Q 10/047; G06Q 30/04; G06Q 2240/00

(57) ABSTRACT

A user segmentation method based on toll data of expressway electronic toll collection (ETC) includes: pre-processing expressway toll data, extracting field information and taking plate numbers of expressway users as a key field to store basic information, thereby to form basic travel data of the expressway users; sorting expressway toll records of the expressway users and cleaning data according to abnormal states of time and space to obtain cleaned expressway toll data; extracting time, space and personal attribute indexes of the expressway user according to the cleaned expressway toll data to form a user classification evaluation index system; and classifying according to the time and space indexes of the expressway users by month, and identifying the commuting travel, the operation travel, the business travel and the sporadic travel. The method has complete information and high precision, and provides a basis for expressway planning and construction.

### TECHNICAL FIELD

The invention relates to a method for identifying and classifying expressway users, in particular to a user segmentation method based on toll data of expressway electronic toll collection (ETC).

### BACKGROUND

Expressway is an integral part of urban traffic, so it is of great significance to master travel demands of expressway users for expressway planning and management. “Outline for Building a Transportation Powerful Country” puts forward higher requirements for expressway operation management and travel service, while the traditional manual toll collection system (MTC) involves less data fields of users, so it can't continuously analyze expressway users. In addition, if manual investigation methods such as traffic survey and questionnaire are used, there are disadvantages such as long cycle, low sampling rate, high cost, etc., and due to the low data quality, it is difficult to achieve expected effects.

With the development of information technology and infrastructure, the ETC system has been widely used, and with the operation of expressway, a large amount of ETC toll data has been generated. The ETC toll data has the characteristic of uniquely identifying users, which realizes one person, one car and one signature, and provides the possibility for identifying the commuting, operation, business and sporadic travels of the expressway users. In October, 2020, the utilization rate of the ETC system is close to 70%, covering most of the expressway users. By mining the travel characteristics of users, it provides an opportunity for more in-depth identification and classification of expressway users.

Self-organizing map (SOM) is a representative semi-supervised machine learning algorithm. Different from the traditional k-means clustering and fuzzy clustering methods, the SOM algorithm does not need to set the initial value of the number of clusters, which makes it easier to operate. It can not only automatically find the internal relationship among sample attributes, but also reduce the dimension and complexity of data. The typical SOM model is a hierarchical structure, generally only having an input layer and a competition layer, so it has great advantages for processing large-scale complex data.

At present, there is no relevant literature report.

### SUMMARY

The technical problem to be solved by the invention is to provide a user segmentation method based on toll data of expressway ETC, which can quickly and accurately identify and classify expressway users, in order to overcome the shortcomings of the prior art.

The technical scheme adopted by the invention is as follows.

The invention provides the user segmentation method based on the toll data of expressway ETC, which has the advantages as follows:
(1) The invention makes full use of the toll data of expressway ETC, and can quickly and accurately classify commuting travel users, daily operation travel users, business travel users and sporadic travel users, thus providing a basis for expressway planning and construction.
(2) The basic data of the invention comes from travel records of expressway ETC users with unique identification, which has characteristics of complete information and high precision compared with the traditional method such as traffic sampling survey and the like.
(3) The SOM classification method adopted by the invention is flexible and easy to use, has obvious advantages for processing large-scale ETC toll data, and can quickly obtain classification results.
(4) The classification results of expressway users can accurately reflect the difference of expressway users in travel time and space distribution, and can provide support for expressway operation and congestion management decisions.

### BRIEF DESCRIPTION OF THE DRAWINGS

FIG. 1 illustrates a flowchart of a user segmentation method based on toll data of expressway ETC according to an embodiment of the invention.

FIG. 2 illustrates a schematic diagram of the SOM clustering according to an embodiment of the invention.

FIG. 3 illustrates a schematic diagram of the classification of expressway users according to an embodiment of the invention.

### DETAILED DESCRIPTION OF THE EMBODIMENTS

A user segmentation method based on toll data of expressway ETC of the present invention will be described in detail with reference to the following embodiments and drawings.

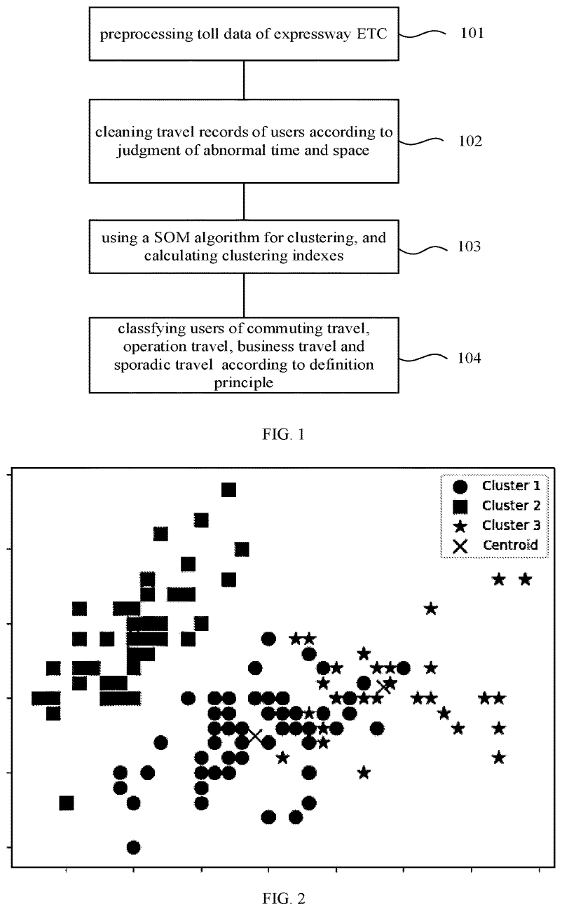

The user segmentation method based on the toll data of expressway ETC of the present invention is to identify travel purposes of commuting travel, operation travel, business travel and sporadic travel of expressway users, as shown in FIG. 1, the user segmentation method based on the toll data of expressway ETC includes the following steps:
1) Pre-processing expressway toll data, extracting field information required by classification of expressway users, and taking plate numbers of expressway users as a key field to store basic information, thereby to form basic travel data of the expressway users; The step 1) specifically includes:
according to the plate numbers of expressway users, sorting the expressway toll records, eliminating abnormal data records with missing fields and wrong plate numbers, and forming the following storage format of the basic travel data:
[plate number, inbound time, inbound location, outbound time, outbound location, billing distance, final toll].
2) Sorting expressway toll records of each expressway user according to time, and cleaning data according to abnormal states of time and space to obtain the expressway toll data after data cleaning (i.e., cleaned expressway toll data);

Where the cleaning data according to the abnormal state of the time includes: reading the outbound time and the inbound time of a travel record (i.e., consumption record) of the expressway user, and calculating the driving time under this travel record; if the driving time is negative, that is, the outbound time is less than the inbound time, or the driving time exceeds 24 hours, determining that this consumption record is the abnormal time data of the expressway user, and eliminating this abnormal time data.

The cleaning data according to the abnormal state of the space includes: reading the outbound time, the inbound time and the billing distance of a travel record of the expressway user, calculating a driving speed under this travel record; if the speed is greater than 120 kilometers per hour (km/h) or the billing distance is greater than 1000 kilometers (km), determining that this consumption record is abnormal space data of the expressway user, and eliminating this abnormal space data.
3) According to the cleaned expressway toll data in step 2), extracting three-dimension information of each expressway user within the set period to form a user classification evaluation index system, and using a SOM clustering algorithm to complete the classification of expressway users; where the three-dimension information of each expressway user includes a time index, a space index and a personal attribute index.

Specifically, a method for extracting the time index of each expressway user includes the following steps: counting numbers of the days for each expressway user to travel on working days and non-working days within the set period respectively, and counting numbers of the days for each expressway user to travel in peak and off-peak periods respectively, where the peak periods include the morning peak period of 7:00-9:00 and the evening peak period of 17:00-19:00 in one day, and the remaining time in one day is the off-peak period.

A method for extracting the space index of each expressway user includes the following steps: extracting starting-ending points of all toll stations in each expressway user's travel within the set period and assigning them with numbers a respectively, then calculating the travel frequency of each expressway user at each starting-ending point according to the numbers, and finally calculating the travel proportion of each expressway user at each starting-ending point. The calculating formulas applied thereto are as follows.

$$C = {\sum }_{a ∈ A} {C}_{a}$$

$${Q}_{a} = \frac{{C}_{a}}{C}$$

Where a represents the number of the starting-ending point of the toll stations, C represents the total travel frequency of the expressway user, A represents a set of all the starting-ending points that the expressway user has passed through, Cₐ represents the travel frequency of the expressway user at the starting-ending point a, and Qₐ represents the travel proportion of the expressway user at the starting-ending point a.

A method for extracting the personal attribute index of the expressway user includes the following steps: calculating the total travel frequency and total travel billing distance of each expressway user within the set period by using an aggregation function. The calculating formulas applied thereto are as follows.

$$C = {\sum }_{a ∈ A} {C}_{a}$$

$$S = {\sum }_{a ∈ A} {C}_{a} * {S}_{a}$$

Where a represents the number of the starting-ending point of the toll stations, C represents the total travel frequency of the expressway user, A represents the set of all the starting-ending points that the expressway user has passed through, Cₐ represents the travel frequency of the expressway user at the starting-ending point a, S represents the total travel billing distance of the expressway user, and Sₐ represents the single billing distance of the starting-ending point a.

The SOM clustering algorithm is used to complete the classification of expressway users, which specially includes: using the SOM clustering algorithm shown in FIG. 2 to input the extracted travel indexes of expressway users in time and space (i.e., extracted space index and time index), and setting the size of the competition layer of the adaptive neural network to N*N, where N represents the number of neurons, which is obtained by the following formula:

$$N = \sqrt[2]{5 \times \sqrt[2]{Sample}} ,$$

where sample represents the number of expressway users.

Cluster analysis is completed by a python-minisom tool in the SOM clustering algorithm, and the average values of the expressway users in each cluster in terms of time and space indexes are calculated according to cluster analysis results, and the following storage format is formed.

$$[ \begin{matrix}\begin{matrix}\begin{matrix}cluster ID \\ time index : travelling during working and non - working days ,\end{matrix} \\ travel during peak and off - peak periods\end{matrix} \\ \begin{matrix}space index : travel proportions at starting - ending points \\ of all toll stations\end{matrix}\end{matrix} ]$$

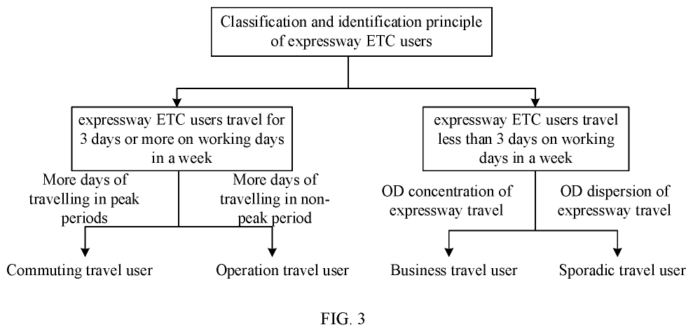

4) As shown in FIG. 3, classifying according to the time index and the space index of the expressway user by month, and identifying all kinds of travel including commuting travel, the operation travel, the business travel and the sporadic travel.

A method for identifying the commuting travel and business travel includes the following steps: selecting at least one cluster ID in which expressway users travel more than 3 days on average on wording days in a week, and then calculating, for the expressway users in the cluster ID, total numbers of days that the expressway users travel in the peak periods (7:00-9:00, 17:00-19:00) and off-peak period respectively, specifically selecting the k-th mouth for calculating,

$${W}_{k} = {\sum }_{i = 1}^{30} {σ}_{i} , {σ}_{i} = \{ \begin{matrix}1 , & \begin{matrix}expressway users travel in the peak periods \\ of a i - th day of the k - th month ;\end{matrix} \\ 0 , & otherwise\end{matrix}$$

$${M}_{k} = {\sum }_{i = 1}^{30} {σ}_{i} , {σ}_{i} = \{ \begin{matrix}1 , & \begin{matrix}expressway users travel in the non - peak period \\ of the i - th day of the k - th month\end{matrix} \\ 0 , & otherwise\end{matrix}$$

where Wₖ represents the total number of the days for the expressway users to travel in the peak periods in the k-th month; Mₖ represents the total number of the days for the expressway users to travel in the off-peak period in the k-th month.

If Wₖ>Mₖ, the expressway users in the cluster ID are defined as the users of the commuting travel (i.e., commuting travel users), otherwise, the expressway users in the cluster ID are defined as the users of the daily operation travel (i.e., operation travel users).

A method for identifying sporadic travel and business travel includes the following steps: selecting at least one cluster ID in which expressway users travel less than 3 days on average on wording days in a week, and then calculating the travel frequency of each starting-ending point in the k-th month for each expressway user:

$${P}_{kj} = {\sum }_{j = 1}^{q} {α}_{j} , {α}_{j} = \{ \begin{matrix}1 , & \begin{matrix}whether the travelling of the expressway user in the k - th month \\ is the j - th origin - destination ( O D )\end{matrix} \\ 0 , & otherwise\end{matrix}$$

$${P}_{k} = {\sum }_{j = 1}^{q} {P}_{kj}$$

where Pₖⱼ represents the travel frequency of the expressway user at the j-th starting-ending point in the k-th the month; Pₖ represents the total travel frequency of expressway user in the k-th month; q represents the total number of the starting-ending points.

The proportion of each starting-ending point of expressway users in this cluster ID in all starting-ending points is calculated. If the maximum proportion of the starting-ending point exceeds 40%, the expressway users in this cluster ID are defined as the users of the business travel; otherwise, the expressway users in this cluster ID are defined as the users of the sporadic travel.

The specific embodiment is described below.

As shown in FIG. 1, according to the method of the invention, the ETC toll data of a certain expressway in July 2019 is classified into commuting, operation, business, and sporadic travel users based on the toll data of expressway ETC.

Step 101: Pre-processing the toll data of expressway ETC.

The toll data of expressway ETC is huge, exceeding 100G. In order to improve the storage efficiency, the key fields are extracted from the original data according to the time and space characteristics, and the expressway toll records are sorted. The abnormal data records such as missing fields and wrong plate numbers are eliminated, and the following basic data storage format is formed, which contains 20 million records and more than 1.4 million users.

[plate number, inbound time, inbound location, outbound time, outbound location, billing distance, final toll]

Step 102: Cleaning user's travel records according to the judgment of abnormal time and space.

Because there are errors in system entry and identification of the toll data of expressway ETC, data cleaning is required before data processing. First, the travel records of each expressway user are sorted according to time, and then the following steps are carried out:

Step 1021: Cleaning the abnormal time data record.

Reading the outbound time and inbound time of a travel record of the expressway user, and calculating the driving time. If the driving time is negative (the outbound time is less than the inbound time), or the driving time exceeds 24 hours, it is determined that this consumption record is the abnormal time data of the expressway user.

Step 1022: Cleaning the abnormal space data record.

Specifically, reading the outbound time, inbound time and billing distance of a travel record of the expressway user, and calculating the driving speed of this travel record. If the driving speed is greater than 120 km/h or the billing distance is greater than 1000 km, it is determined that this consumption record is the abnormal space data of the expressway user. After the data cleaning, there are about 1.35 million expressway users left.

Step 1023: Extracting travel indexes of user's time, space and personal attribute.

Counting the days of working-day travel and non-working-day travel in the cycle, with 7:00-9:00 as the morning peak and 17:00-19:00 as the evening peak, and counting the days in the peak-period-travel and off-peak-period travel; Counting the travel frequency of each starting and ending point in the travel of the expressway user, and calculating the proportion of the starting and ending point in all travels; The aggregate function is used to calculate the total travel frequency and total travel billing distance of each expressway user in the set period, so as to obtain the travel indexes of all expressway users. The travel indexes of the certain expressway user are as follows.

| | | Travel | | Travel | Proportion | Proportion | | |
|---|---|---|---|---|---|---|---|---|
| | Travel | days in | Travel | days in | of | of | | |
| User | days in | non- | days in | non- | starting- | starting- | Total | Total |
| plate | working | working | peak | peak | ending | ending | travel | travel |
| number | days | days | periods | period | point 1 | point 2 | days | distance |
| ***** | 21 | 2 | 20 | 3 | 80% | 20% | 41 | 714 |

Step 103: Using the SOM clustering to complete expressway user clustering.

Python-minisom, a tool of the SOM clustering method, is used to cluster and analyze the above-mentioned time, space and personal attribute indexes of expressway users. The input parameters of the SOM clustering algorithm include the travel days in working days of the expressway user, the travel days in non-working days of the expressway user, the travel days in peak periods of the expressway user, the travel days in non-peak period of the expressway user, the most commonly used proportion of the starting-ending points in all travels, and the size of the competition layer of the adaptive neural network is set to N×N=76×76.

After the SOM clustering, six classifications are finally obtained, and then the averages of all users' travel indexes in this cluster are calculated according to the cluster ID, and the following data format is formed for each cluster.

| Index | cluster 1 | cluster 2 | cluster 3 | cluster 4 | cluster 5 | cluster 6 |
|---|---|---|---|---|---|---|
| Average travel | 3.33 | 0.32 | 1.38 | 3.39 | 0.29 | 0.61 |
| days on working | | | | | | |
| days in a week | | | | | | |
| Travel days | 2.34 | 0.11 | 0.49 | 1.37 | 0.09 | 0.16 |
| during peak | | | | | | |
| periods | | | | | | |
| Travel days | 0.57 | 0.13 | 0.48 | 2.02 | 0.07 | 0.16 |
| during off-peak | | | | | | |
| period | | | | | | |
| Travel | 34% | 11% | 49% | 32% | 8% | 20% |
| proportion of | | | | | | |
| most commonly | | | | | | |
| used starting- | | | | | | |
| ending point | | | | | | |
| Number of | 11863 | 537828 | 135475 | 9565 | 236624 | 426569 |
| vehicles of | | | | | | |
| expressway users | | | | | | |

Step 104: Dividing commuting, operation, business and sporadic users according to the identification principle of expressway users.

The average weekly travel days of expressway users in cluster 1 and cluster 4 are more than three times, but the travel days of users in cluster 1 are more concentrated in peak periods, while those in cluster 4 are more dispersed, so cluster 1 is defined as commuting travel users, while cluster 4 is defined as operation travel users. The remaining of cluster 2, cluster 3, cluster 5 and cluster 6 have fewer travel days, with less than 3 travel days per week on working days. However, among the travel days of cluster 3, the most commonly used starting-ending point travels account for more than 40%, and the travel routes are concentrated, so cluster 3 is defined as business travel users, while the remaining of cluster 2, cluster 5 and cluster 6 are defined as sporadic travel users.

The above embodiment are provided only for the purpose of describing the present invention, and are not intended to limit the scope of the present invention. The scope of the invention is defined by the appended claims. All equivalent substitutions and modifications made without departing from the spirit and principle of the present invention should be included in the scope of the present invention.

What is claimed is:

1. A user segmentation method based on toll data of expressway electronic toll collection (ETC), aiming to identify travel purposes of commuting travel, operation travel, business travel and sporadic travel of expressway users, wherein the user segmentation method comprises the following steps:
step 1) pre-processing expressway toll data within a set period, extracting field information required by classification of the expressway users, and taking plate numbers of the expressway users as a key field to store basic information, thereby to form basic travel data of the expressway users;
step 2) sorting expressway toll records of the expressway users in the set period according to time, and cleaning data according to abnormal states of time and space to obtain cleaned expressway toll data;
step 3) extracting three-dimension information of each of the expressway users in the set period according to the cleaned expressway toll data in step 2) to form a user classification evaluation index system, and using a self-organizing map (SOM) clustering algorithm to complete the classification of the expressway users; wherein the three-dimension information of each the expressway user comprises a time index, a space index and a personal attribute index; and
step 4) classifying according to the time index and the space index of each the expressway user by month, and identifying the commuting travel, the operation travel, the business travel and the sporadic travel.

2. The user segmentation method based on the toll data of expressway ETC according to claim 1, wherein step 1) comprises: sorting the expressway toll records in the set period according to the plate numbers of the expressway users, and eliminating abnormal data records with missing fields and wrong plate numbers, thereby forming a storage format of the basic travel data as follows:
[plate number, inbound time, inbound location, outbound time, outbound location, billing distance, final toll].

3. The user segmentation method based on the toll data of expressway ETC according to claim 1, wherein in step 2), the cleaning data according to the abnormal state of the time comprises:
reading the outbound time and the inbound time of a consumption record of each the expressway user in the set period, and calculating driving time under the consumption record; if the driving time is negative, that is, the outbound time is less than the inbound time, or the driving time exceeds 24 hours, determining that the consumption record is abnormal time data of the expressway user, and eliminating the abnormal time data.

4. The user segmentation method based on the toll data of expressway ETC according to claim 1, wherein in step 2), the cleaning data according to the abnormal state of the space comprises:
reading the outbound time, the inbound time and the billing distance of a consumption record of each the expressway user in the set period, and calculating a driving speed under the consumption record; if the driving speed is greater than 120 kilometers per hour (km/h) or the billing distance is greater than 1000 kilometers (km), determining that the consumption record is abnormal space data of the expressway user, and eliminating the abnormal space data.

5. The user segmentation method based on the toll data of expressway ETC according to claim 1, wherein in step 3), the extracting the time index of each the expressway user comprises:
counting numbers of days for each the expressway user to travel on working days and non-working days in the set period respectively, and counting numbers of days for each the expressway user to travel in peak periods and an off-peak period respectively, wherein the peak periods comprise a morning peak period of 7:00-9:00 and an evening peak period of 17:00-19:00 in one day, and a remaining time in the one day is the off-peak period.

6. The user segmentation method based on the toll data of expressway ETC according to claim 1, wherein in step 3), the extracting the space index of each the expressway user comprises:
extracting starting-ending points of all toll stations of travelling by each the expressway user within the set period and assigning the starting-ending points as numbers a, then counting a travel frequency of each the expressway user at each of the starting-ending points within the set period according to the numbers, and calculating a travel proportion of each the expressway user at each the starting-ending point; wherein calculating formulas applied thereto are as follows:
$$C = {\sum }_{a}^{A} {C}_{a}$$
$${Q}_{a} = \frac{{C}_{a}}{C}$$
where a represents the number of the starting-ending point of the toll stations, C represents a total travel frequency of each the expressway user within the set period, A represents a set of all the starting-ending points that the expressway user has passed through within the set period, Cₐ represents the travel frequency of each the expressway user at the starting-ending point a within the set period, Qₐ represents the travel proportion of each the expressway user at the starting-ending point a within the set period.

7. The user segmentation method based on the toll data of expressway ETC according to claim 1, wherein in step 3), the extracting the personal attribute index of each the expressway user comprises:
calculating a total travel billing distance of each the expressway user within the set period by an aggregation function, wherein a calculating formula applied thereto is as follows:
$$S = {\sum }_{a}^{A} {C}_{a} * {S}_{a}$$
where a represents the number of the starting-ending point of the toll stations, A represents a set of all the starting-ending points that the expressway user has passed through within the set period, S represents the total travel billing distance of the expressway user, and Sₐ represents a single billing distance of the starting-ending point a.

8. The user segmentation method based on the toll data of expressway ETC according to claim 1, wherein in step 3), the using the SOM clustering algorithm to complete the classification of the expressway users, comprises:
inputting the extracted time index and the extracted space index of each the expressway user by the SOM clustering algorithm, and setting a size of a competition layer of an adaptive neural network as N*N, where N represents a number of neurons, which is obtained by the following formula:
$$N = \sqrt[2]{5 \times \sqrt[2]{Sample}} ,$$
where sample represents a number of the expressway users;
completing clustering analysis by a python-minisom tool in the SOM clustering algorithm, and calculating average values of the expressway users in the time index and the space index in each cluster according to clustering analysis results to form a storage format as follows:
$$[ \begin{matrix}\begin{matrix}\begin{matrix}cluster ID \\ time index : travelling during working and non - working days ,\end{matrix} \\ travelling during peak and off - peak periods\end{matrix} \\ \begin{matrix}space index : travel proportions at starting - ending points \\ of all toll stations\end{matrix}\end{matrix} ] .$$

9. The user segmentation method based on the toll data of expressway ETC according to claim 1, wherein in step 4), a method of identifying the commuting travel and the operation travel comprises:
selecting at least one cluster ID where the expressway users travel more than 3 days on average on working days in a week; and calculating, for the expressway users in the cluster ID, total numbers of days that the expressway users travel in the peak and off-peak periods respectively, the peak periods being 7:00-9:00 and 17:00-19:00, and specifically selecting a k-th mouth for the calculating:
$${W}_{k} = {\sum }_{i = 1}^{30} {σ}_{i} , {σ}_{i} = \{ \begin{matrix}1 , & \begin{matrix}expressway users travel in the peak periods \\ of a i - th day of the k - th month ;\end{matrix} \\ 0 , & otherwise\end{matrix}$$
$${M}_{k} = {\sum }_{i = 1}^{30} {σ}_{i} , {σ}_{i} = \{ \begin{matrix}1 , & \begin{matrix}expressway users travel in the non - peak period \\ of the i - th day of the k - th month\end{matrix} \\ 0 , & otherwise\end{matrix}$$
where Wₖ represents the total number of the days for the expressway users to travel in the peak periods in the k-th month; Mk represents the total number of the days for the expressway users to travel in the off-peak period in the k-th month;
wherein if Wₖ>Mₖ, the expressway users in the cluster ID are defined as users of the commuting travel, otherwise, the expressway users in the cluster ID are defined as users of the operation travel.

10. The user segmentation method based on the toll data of expressway ETC according to claim 1, wherein a method of identifying the business travel and the sporadic travel, comprises:
selecting at least one cluster ID where the expressway users travel less than 3 days on average on working days in a week; and calculating, for each of the expressway users in the cluster ID, a travel frequency of the expressway user at each of starting-ending points in the k-th month;
$${P}_{kj} = {\sum }_{j = 1}^{q} {α}_{j} , {α}_{j} = \{ \begin{matrix}1 , & \begin{matrix}travelling of the expressway user in the k - th month \\ is the j - th starting - ending point\end{matrix} \\ 0 , & otherwise\end{matrix}$$
$${P}_{k} = {\sum }_{j = 1}^{q} {P}_{kj}$$
where Pₖⱼ represents the travel frequency of the expressway user at the j-th starting-ending point in the k-th month; Pₖ represents a total travel frequency of the expressway user in the k-th month; q represents a total number of the starting-ending points;
calculating, for the expressway users in the cluster ID, a proportion of each the starting-ending point of the expressway users in all the starting-ending points; wherein if a maximum of the proportions of the starting-ending points exceeds 40%, the expressway users in the cluster ID are defined as users of the business travel; otherwise, the expressway users in the cluster ID are defined as users of the sporadic travel.
